(19) United States
(12) Patent Application Publication
(10) Pub. No.: US 2019/0230950 A1
(43) Pub. Date: Aug. 1, 2019

(54) Improved Method for Processing and Extracting Oil from Marine Organisms

(71) Applicants: Philip Samuel, Bangalore (IN); Ajay Iyer, Bangalore (IN)

(72) Inventors: Philip Samuel, Bangalore (IN); Ajay Iyer, Bangalore (IN)

(21) Appl. No.: 16/327,580

(22) PCT Filed: Nov. 9, 2016
(86) PCT No.: PCT/IN2016/000265

§ 371 Date: Feb. 22, 2019

(30) Foreign Application Priority Data
Aug. 24, 2016 (IN) 201641028780

(51) Int. Cl. A23D 9/02; A23D 9/013

(52) U.S. Cl. CPC A23D 9/02; C11B 1/10; A23D 9/013

(57) ABSTRACT

An improved method for processing and extracting krill oil from krill meal/fresh krill. The proposed method for processing and extracting of krill oil from krill meal/fresh krill can be a very simple, cost effective and productive approach. The krill oil obtained herein can meet industrial standards and requirements of a wide range of applications including nutraceuticals and pharmaceutical applications. The method can be’ alternatively adapted to process and extract a wide range of marine oils including, but not limited to, Fish, Salmon, Shrimp, Cod and other marine product varieties.

### TECHNICAL FIELD

The present invention generally relates to the field of marine organisms and products. The present invention also relates to production of oil from marine organisms and products obtained thereby for human and animal consumption. The present invention is particularly related to methods for processing and extracting oil from marine organisms and related products. The present invention more particularly relates to an improved method for processing and extracting oil from marine crustaceans particularly krill.

### BACKGROUND OF THE INVENTION

Modern research on oil from marine organisms and related products indicate to have highly beneficial and preventive effects on both human and animal health due their high content of marine phospholipids (polyunsaturated fatty acids), especially the omega-3 fatty acids, eicosapentaenoic acid (20:5 n-3; EPA) and docosahexaenoic acid (22:6 n-3; DHA). In particular, research on omega-3 fatty acids has been reported for numerous conditions such as cardiovascular diseases, atherosclerosis, and several types of cancer, dyslipidemia, hypertension, diabetes, obesity, inflammatory diseases, neurological/neuropsychiatric disorders, asthma and rheumatoid arthritis.

Marine products such as fish milt and roe are traditional raw materials for marine phospholipids. However, these raw materials are available in limited volumes and the price of said raw materials is high. Krill is a small crustacean, shrimp like organism, containing relatively high concentrations of phospolipids found in all the major oceans worldwide. Krill is the key species in the ocean as it is the food source for many animals such as fish, birds, sharks and whales. Krill can be found in large quantities in the ocean.

Krill oil is a unique oil containing omega-3 or n-3 fatty acids along with bioactive eicosapentaenoic acid (EPA) and docosahexaenoic acid (DHA) with rich phospholipids and triglycerides. Methods for processing and extracting oil from marine organisms, particularly from krill meal/fresh krill are well known in the art. Majority of prior art methods use alcohol or any polar solvents to process and extract oil from krill meal/fresh krill. Such prior art methods are unable to effectively process the unwanted waste in the marine products and retain the natural benefits of the marine oil. Furthermore, the prior art methods and processes for processing and extracting marine oils are complex and cost consuming.

Based on the foregoing a need therefore exists for an improved system and method for producing oil from marine organisms. A need also exists for an improved method for processing and extracting oil from marine organisms, in particular krill oil from krill meal/fresh krill in a simple and cost effective approach, as described in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

Therefore, one aspect of the disclosed embodiment is to provide for an improved method and process for production of oil from marine organism including krill, fish and other marine related products.

It is another aspect of the disclosed embodiment to provide for an improved krill oil extraction process.

It is further aspect of the disclosed embodiment to provide for an improved method for processing and extracting krill oil from krill meal/fresh krill in a simple and cost effective approach.

The aforementioned aspects and other objectives and advantages can now be achieved as described herein. An improved method for processing and extracting krill oil from krill meal/fresh krill, is disclosed herein. The raw krill meal/krill can be initially added and stirred with pure Acetone at RM:Solvent Ratio (1:5 to 1:40) and at a determined temperature (ambient to 50°) for a defined time period (2-6 hours).

Alternatively, the raw krill meal/krill can be added and stirred with methanol at RM:Solvent Ratio (1:5 to 1:40) and at a determined temperature (ambient to 50°) for a defined time period (2-6 hours). In the context of Acetone treated krill, the acetone treated krill can be filtered and passed through a dry bed packed with a hygroscopic salt (i.e., MgSO₄ or Na₂SO₄) with a weight equal to or more than the water content in the extract. The dried extract of krill can be recovered and the solvent in the extract can be evaporated through solvent evaporation technique to obtain krill oil.

In the context of Methanol treated krill, the extract can carried forward to get the desired extract using evaporation technique to remove the methanol. The intermediate spent krill portion can be added and stirred with pure Acetone at RM:Solvent Ratio (1:5 to 1:40) and at a determined temperature (ambient to 50°) for a defined time period (2-6 hours). The liquid extract can be further mixed with evaporated Methanol extract for a suitable time at a determined temperature (ambient to 50° C.) and thereafter filtered to recover the liquid filtrate. The liquid filtrate can be evaporated to remove the solvent and extract krill oil.

In another embodiment, the Methanol treated krill extract can be fractionated (fractionate) in Hexane (non-polar solvent) of equal volume as the polar solvent in the extract using a counter current chromatography. The Hexane layer can be separated and recovered from the extract and the solvent in the extract can be evaporated using evaporation technique to obtain krill oil.

The proposed approach of using counter current chromatography allows for the execution of the process in a semi-continuous manner; thereby increasing daily throughput. The krill oil obtained in this approach has a relatively lower odor as compared to other commercially available krill oils. The proposed approach can be used for effectively processing a wide range of oil compositions thereby allowing for several products with novel composition by maintaining the desired oil consistency despite natural variations in krill raw material.

Note that the Acetone used herein for treating the krill meal/fresh krill can be alternatively replaced with any ketone or hygroscopic solvent or combination thereof. The anhydrous hygroscopic salt used in the dry pack bed, especially the sulfated salt of any alkali metal, allows for rapid removal of water from the protic polar solvent used in the extraction process. This reduces the hindrance which is often faced during the subsequent evaporation stage. A person skilled in the art may be relatively able to understand the phenomenon and appreciate the outcome.

Interaction of the anhydrous salt and solvent extract leads to precipitation of certain fats and proteins from the extract which helps in decreasing the viscosity of the final krill oil and increase the levels of certain bioactive such as, for example, but not limited to, DHA and phospholipids. The sulfated alkali metal is non-toxic and does not pollute bio-accumulate or harm the environment in any way. Simple water treatment along with reverse osmosis can help recover the salt for reuse in subsequent batches.

Similarly, the Methanol used herein for treating krill meal/fresh krill can be alternatively replaced with any solvable alcohol or any protic polar solvent or combination thereof. Treatment of portions of krill extract with Methanol extraction and Acetone allows for removal of unwanted fats and proteins in the extract which are retained in the methanol fraction. The ketone allows for recovery of the desired low viscosity oil from the extract which is rich in unsaturated fatty acids. The by-product of methanol fraction can be high in certain forms of phospholipids and saturated fats which can be adapted in nutraceutical and pharmaceutical applications.

Complete exhaustion of all lipid matter from the krill spent renders it easier for further processing of chitosan extiaction processes. By obtaining separate methanol and acetone fractions; each with their own unique biomolecular compositions, the fractions can be blended either to suit a particular desired product composition, or to maintain the consistency of the desired oil product by overcoming the natural variations observed in the krill raw material. The proposed method for processing and extracting of krill oil from krill meal/fresh krill can be a very simple, cost effective and productive approach.

The krill oil obtained herein can meet industrial standards and requirements of a wide range of applications including nutraceuticals and pharmaceutical applications. Note that the method proposed herein should not be constituted in any limited sense as an approach for extracting krill oil, the method can be alternatively adapted to process and extract a wide range of oil from marine organisms including, but not limited to, Fish, Salmon, Shrimp, Cod and other marine product varieties within the scope of the present invention.

### BRIEF DESCRIPTION OF DRAWINGS

The drawings shown here are for illustration purpose and the actual system will not be limited by the size, shape, and arrangement of components or number of components represented in the drawings.

FIG. 1 illustrates a method for processing and extracting of krill oil from krill meal/fresh krill using Acetone and hygroscopic salts, in accordance with the disclosed embodiments;

FIG. 2 illustrates an alternate method for processing and extracting of krill oil from krill meal/fresh krill using Methanol extraction process, in accordance with the disclosed embodiments; and

FIG. 3 illustrates an alternate method for processing and extracting of krill oil from krill meal/fresh krill using Methanol extraction process and counter current chromatography, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

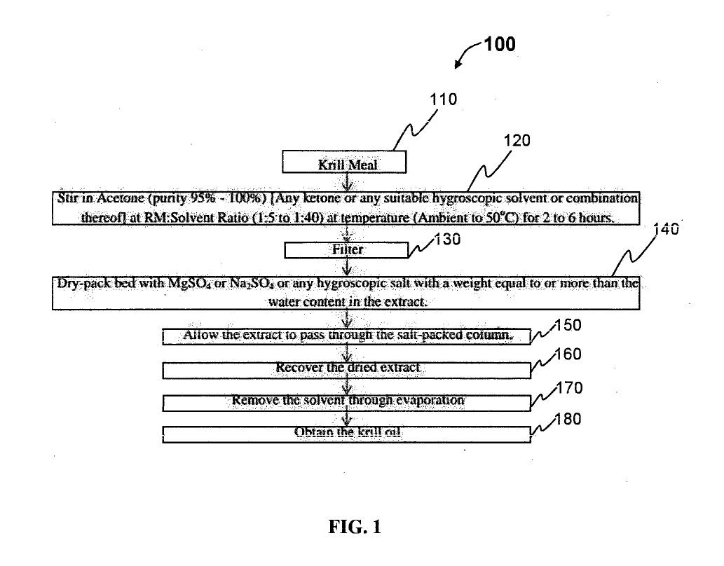

FIG. 1 illustrates a method 100 for processing and extracting of krill oil from krill meal/fresh krill using Acetone and hygroscopic salts, in accordance with the disclosed embodiments. The raw krill meal/krill can be initially added and stirred with pure Acetone at RM:Solvent Ratio (1:5 to 1:40) and at a determined temperature (ambient to 50° C.) for a defined time period (2-6 hours), as disclosed at block 110 and 120. Note that the Acetone used herein for treating the krill meal/fresh krill can be alternatively replaced with any ketone or hygroscopic solvent or combination thereof. The acetone treated krill can be filtered and passed through a dry bed packed with a hygroscopic salt (i.e., MgSO₄ or Na₂SO₄) with a weight equal to or more than the water content in the exact, as illustrated at block 130 and 140. The anhydrous hygroscopic salt used in the dry pack bed, especially the sulfated salt of any alkali metal, allows for rapid removal of water from the protic polar solvent used in the extraction process. This reduces the hindrance which is often faced during the subsequent evaporation stage. A person skilled in the art may be able to understand the phenomenon and appreciate the outcome. The dried extract of krill can be recovered and the solvent in the extract can be evaporated through solvent evaporation technique to obtain krill oil, as illustrated at block 150-180. Interaction of the anhydrous salt and solvent extract leads to precipitation of certain fats and proteins from the extract which helps in decreasing the viscosity of the final krill oil and increase the levels of certain bioactive such as, for example, but not limited to, DHA and phospholipids. The sulfated alkali metal is non-toxic and does not pollute bio-accumulate or harm the environment in any way. Simple water treatment along with reverse osmosis can help recover the salt for reuse in subsequent batches.

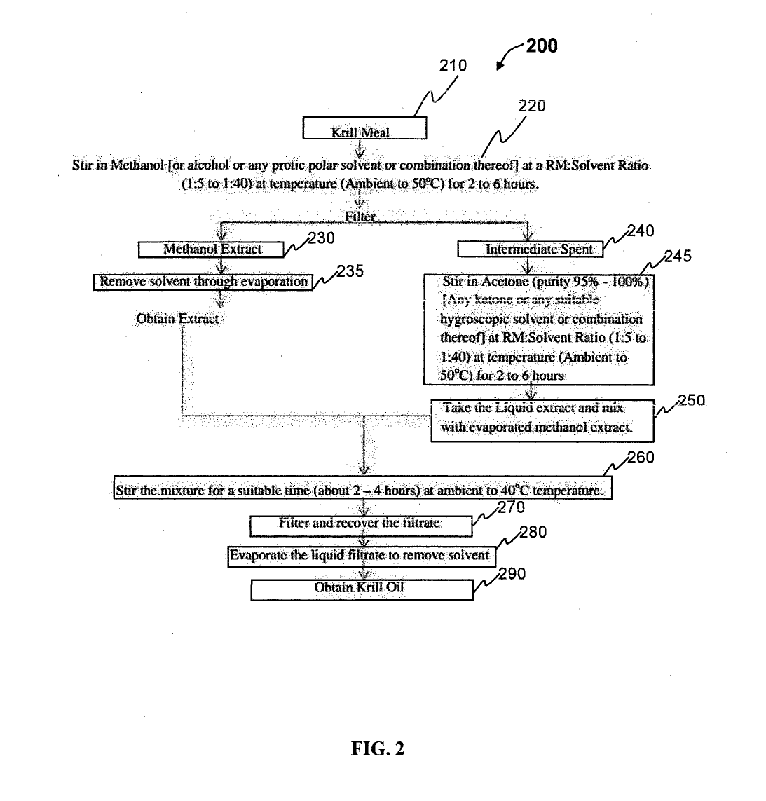

FIG. 2 illustrates an alternate method 200 for processing and extracting of krill oil from krill meal/fresh krill using Methanol extraction process, in accordance with the disclosed embodiments. The raw krill meal/krill can be added and stirred with methanol at RM:Solvent Ratio (1:5 to 1:40) and at a determined temperature (ambient to 50° C.) for a defined time period (2-6 hours), as shown at block 210 and 220. Note that the Methanol used herein for treating krill meal/fresh krill can be alternatively replaced with any solvable alcohol or any protic polar solvent or combination thereof. The methanol from the methanol extract, is removed through evaporation technique, as illustrated at block 230 and 235.

The intermediate spent is stirred with pure Acetone at RM:Solvent Ratio (1:5 to 1:40) and at a determined temperature (ambient to 50° C.) for a defined time period (2-6 hours), as illustrated at block 240 and 245. The liquid extract can be further mixed with evaporated Methanol extract for a suitable time at a pre-determined temperature (ambient to 50° C.), as shown at block 250 and 260. The extract can be further filtered to recover the liquid filtrate, as illustrated at block 270. The liquid filtrate can be evaporated to remove the solvent and extract krill oil as illustrated in 280 and 290.

Treatment of portions of krill extract with Methanol extraction and Acetone allows for removal of unwanted fats and proteins in the extract which are retained in the methanol fraction. The ketone allows for recovery of the desired low viscosity oil from the extract which is rich in unsaturated fatty acids. The by-product of methanol fraction can be high in certain forms of phospholipids and saturated fats which can be adapted in nutraceutical and pharmaceutical applications. Complete exhaustion of all lipid matter from the spent krill renders it easier for further processing of chitosan extraction processes. By obtaining separate methanol and acetone fractions; each with their own unique biomolecular compositions, the fractions can be blended either to suit a particular desired product composition or to maintain the consistency of the desired oil product by overcoming the natural variations observed in the krill raw material.

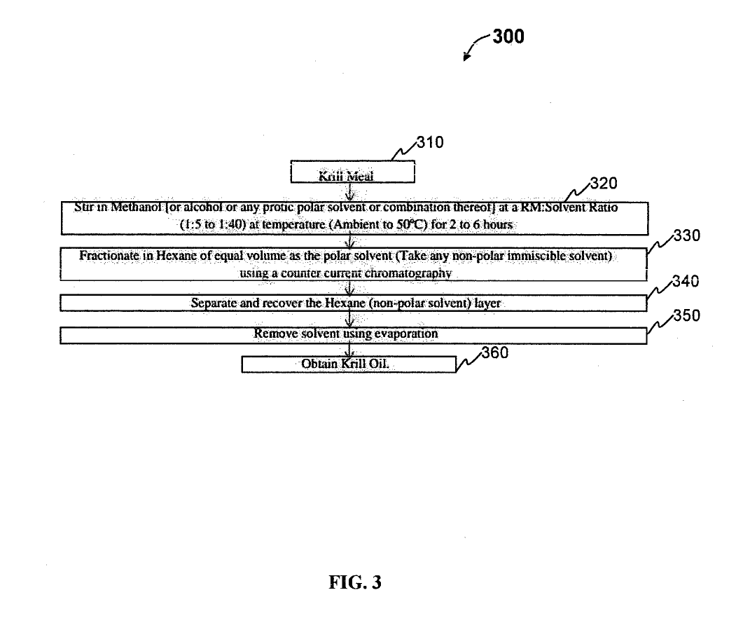

FIG. 3 illustrates an alternate method 300 for processing and extracting of krill oil from krill meal/fresh krill using Methanol extraction process and counter current chromatography, in accordance with the disclosed embodiments. The raw krill meal/krill can be added and stirred with methanol at RM:Solvent Ratio (1:5 to 1:40) and at a determined temperature (ambient to 50° C.) for a defined time period (2-6 hours), as illustrated at block 310 and 320. Again note that the Methanol used herein for treating krill meal/fresh krill can be alternatively replaced with any solvable alcohol or any protic polar solvent or combination thereof. The Methanol treated krill can be fractionated (fractionate) in Hexane (non-polar solvent) of equal volume as the polar solvent in the extract using a counter current chromatography, as depicted at block 330. The Hexane layer can be separated and recovered from the extract, as shown at block 340. The solvent in the extract can be evaporated using evaporation technique to obtain krill oil, as depicted at block 350-360.

The proposed approach of using counter current chromatography allows for the execution of the process in a semi-continuous manner; thereby increasing daily throughput. The krill oil obtained in this approach has a relatively lower odor as compared to other commercially available krill oils. The proposed approach can be used for effectively processing a wide range of oil compositions thereby allowing for several products of novel composition by maintaining the desired oil consistency despite natural variations in krill raw material. The proposed method for processing and extracting of krill oil from krill meal/fresh krill can be a very simple, cost effective and productive approach.

The krill oil obtained herein can meet industrial standards and requirements of a wide range of applications including nutraceuticals and pharmaceutical applications. Note that the method proposed herein should not be constituted in any limited sense as an approach for extracting krill oil, the method can be alternatively adapted to process and extract a wide range of oil from marine organisms including, but not limited to, Fish, Salmon, Shrimp, Cod and other marine product varieties within the scope of the present invention.

It will be appreciated that variations of the above-disclosed and other features and functions, or alternatives thereof may be desirably combined into many other different systems or applications. Also that various presently unforeseen or unanticipated alternatives, modifications, variations or improvements therein may be subsequently made by those skilled in the art which are also intended to be encompassed by the following claims.

I/We claim:

1. A method for processing and extracting krill oil from krill meal/fresh krill, said method comprising:
adding and stirring said krill meal/fresh krill with pure Acetone at RM:Solvent Ratio (1:5 to 1:40) and at a determined temperature (ambient to 50° C.) for a defined time period (2-6 hours); and
filtering said krill extract and passing through a dry bed packed with a hygroscopic salt (i.e., MgSO₄ or Na₂SO₄) with a weight equal to or more than the water content in the exact wherein said dried extract of krill can be recovered and solvent in the extract can be evaporated through solvent evaporation technique to obtain krill oil.

2. The method of claim 1 further comprising:
adding and stirring said raw krill meal/krill methanol at RM:Solvent Ratio (1:5 to 1:40) and at a determined temperature (ambient to 50° C.) for a defined time period (2-6 hours);
filtering methanolic krill extract and evaporate the methanol from the solvent to get the extract;
adding and stirring the intermediate spent krill with pure Acetone at RM:Solvent Ratio (1:5 to 1:40) and at a determined temperature (ambient to 50° C.) for a defined time period (2-6 hours) wherein the extract can be mixed with evaporated Methanol extract for a suitable time at a determined temperature (ambient to 50° C.); and
evaporating the liquid filtrate to remove the solvent and extract krill oil.

3. The method of claim 2 further comprising fractionating said Methanol treated krill in Hexane (non-polar solvent) of equal volume as the polar solvent in the extract using a counter current chromatography.

4. The method of claim 3 further comprising separating Hexane layer recovered from the krill extract and evaporating the solvent in the extract can be evaporated using evaporation technique to obtain krill oil.

5. The method of claim 3 wherein counter current chromatography allows for the execution of the process in a semi-continuous manner; thereby increasing daily throughput of krill oil.

6. The method of claim 1 wherein said Acetone for treating krill meal/fresh krill can be alternatively replaced with at least one of the following:
Ketone;
Alcohol; and
hygroscopic solvent or combination thereof.

7. The method of claim 1 wherein the hygroscopic salt used as the dry pack bed allows for rapid removal of water from the protic polar solvent used in the extraction process thereby reduces the hindrance which is often faced during the subsequent evaporation stage.

8. The method of claim 2 wherein the Methanol for treating krill meal/fresh krill can be alternatively replaced with one of the following: solvable alcohol; and protic polar solvent or combination thereof.

9. The method of claim 2 wherein treatment of portions of krill extract with Methanol extraction and Acetone allows for removal of unwanted fats and proteins in the extract which are retained in the methanol fraction wherein the Acetone allows for recovery of the desired low viscosity oil from the extract which is rich in unsaturated fatty acids.

10. The method of claim 1 wherein the method can be alternatively adapted to process and extract a wide range of marine oils including Fish, Salmon, Shrimp, Cod and other marine product varieties.
